(19) United States
(12) Patent Application Publication
(10) Pub. No.: US 2026/0021747 A1
(43) Pub. Date: Jan. 22, 2026

(54) LINEAR INERTIAL LATCH

(71) Applicant: Camaco, LLC, Farmington Hills, MI (US)

(72) Inventors: Pradeep Akkineni, Farmington Hills, MI (US); Jeffrey Carroll, West Bloomfield, MI (US); Ashok Singh, Farmington Hills, MI (US); Manoj Srivastava, Novi, MI (US)

(73) Assignee: Camaco, LLC, Farmington Hills, MI (US)

(21) Appl. No.: 19/269,521

(22) Filed: Jul. 15, 2025

Related U.S. Application Data
(60) Provisional application No. 63/672,486, filed on Jul. 17, 2024.

(51) Int. Cl. B60N 2/015; B60N 2/30

(52) U.S. Cl. CPC B60N 2/01516; B60N 2/305

(57) ABSTRACT

A linear inertial latch assembly includes a bracket configured to couple to a stationary portion of a vehicle seat and a linear inertial latch configured to couple to a moving portion of the vehicle seat. The linear inertial latch includes a housing defining an interior chamber and a pin aperture extending through the housing, a pin disposed within the interior chamber, and a biasing element disposed within the interior chamber. The pin is configured to extend outward from the housing through the pin aperture from a retracted position to an engagement position to engage the bracket. The biasing element is configured to provide a biasing force to the pin to bias the pin toward the retracted position. Responsive to an acceleration of the linear inertial latch being greater than or equal to an acceleration threshold, the pin overcomes the biasing force and translates into the engagement position.

### CROSS-REFERENCE TO RELATED PATENT APPLICATIONS

This application claims the benefit of and priority to U.S. Provisional Application No. 63/672,486, filed Jul. 17, 2024, the entire contents of which are hereby incorporated by reference herein.

### BACKGROUND

A vehicle may include a vehicle seat that includes a moving portion that may be adjusted by an occupant of the vehicle for providing additional storage space in the vehicle. For example, a rear seat in a vehicle may fold forward to provide additional storage space to a storage compartment of the vehicle. The moving portion of the vehicle seat may be coupled to the stationary portion of the vehicle with an adjustment system configured to pivotably couple the moving portion to the stationary portion and to allow the occupant to adjust an orientation of the moving portion relative to the stationary portion. However, in vehicles with traditional seats, under certain acceleration conditions of the vehicle, unintended movement of the moving portion of the vehicle seat relative to the stationary portion may occur. For example, a rapid deceleration of the vehicle when the vehicle is in an accident may cause the moving portion of the vehicle seat to move relative to the stationary portion. The unintended movement of the moving portion of the vehicle seat may result in injuries to an occupant of the vehicle seat or damage to objects supported by the vehicle seat. Additionally, even if the vehicle seat includes an externally actuated locking component configured to secure the moving portion of the vehicle seat to the stationary portion, an operator of the vehicle may forget to externally actuate the externally actuated locking component to secure the moving portion of the vehicle seat to the stationary portion, allowing for the unintended movement of the moving portion of the seat relative to the stationary portion to still occur. Therefore, it would be advantageous to provide a vehicle seat or a modular kit to modify an existing vehicle seat that secures a moving portion of the vehicle seat to a stationary portion of the vehicle when an acceleration of the vehicle is greater than or equal to an acceleration threshold.

### SUMMARY

One embodiment relates to a linear inertial latch assembly for securing a moving portion of a vehicle seat to a stationary portion of the vehicle seat or a vehicle within which the vehicle seat is installed. The linear inertial latch assembly includes a bracket configured to couple to the stationary portion and a linear inertial latch configured to couple to the moving portion of the vehicle seat. The linear inertial latch includes a housing defining an interior chamber and a pin aperture extending through the housing, a pin at least partially disposed within the interior chamber, and a biasing element disposed within the interior chamber. The pin is configured to selectively extend outward from the housing through the pin aperture from a retracted position to an engagement position to engage the bracket to secure the moving portion of the vehicle seat to the stationary portion. The biasing element is configured to provide a biasing force to the pin to bias the pin toward the retracted position. Responsive to an acceleration of the linear inertial latch being greater than or equal to an acceleration threshold, the pin overcomes the biasing force and translates into the engagement position such that the pin engages the bracket to secure the moving portion relative to the stationary portion.

Another embodiment relates to a frame assembly for a vehicle. The frame assembly includes a frame portion, a seat portion of a vehicle seat, and a linear inertial latch assembly for securing the seat portion to the frame portion. The seat portion is pivotably coupled to the first frame portion. The linear inertial latch assembly includes a bracket coupled to the frame portion and a linear inertial latch coupled to the seat portion. The linear inertial latch is configured to selectively transition from a retracted configuration to an extended configuration to engage the bracket to secure the seat portion to the frame portion. Responsive to an acceleration of the linear inertial latch being greater than or equal to an acceleration threshold, the linear inertial latch transitions from the retracted configuration to the extended configured to secure the seat portion relative to the frame portion.

Yet another embodiment relates to a linear inertial latch. The linear inertial latch includes a housing defining an interior chamber and a pin aperture extending through the housing, a pin at least partially disposed within the interior chamber, and a biasing element disposed within the interior chamber and configured to provide a biasing force to the pin to bias the pin toward the retracted position. The pin is configured to selectively extend outward from the housing through the pin aperture from a retracted position to an engagement position to engage a stationary element. The pin includes a body portion received within the interior chamber and a mandrel portion coupled to the body portion and extending through the pin aperture. Responsive to an acceleration of the linear inertial latch being greater than or equal to an acceleration threshold, the pin overcomes the biasing force and translates into the engagement position such that the pin engages the stationary element.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a side view of a vehicle, according to an exemplary embodiment.

FIG. 2 is a front perspective view of a cabin of the vehicle of FIG. 1 including seats, according to an exemplary embodiment.

FIG. 3 is side view of a frame assembly of a seat of the vehicle of FIG. 2 in a first position, according to an exemplary embodiment.

FIG. 4 is a side view of the frame assembly of FIG. 3 in a second position, according to an exemplary embodiment.

FIG. 5 is a side view of the frame assembly of FIG. 3 in a third position, according to an exemplary embodiment.

FIG. 6 is a side view of a frame assembly of the seat of FIG. 3 in the first position with an inertial latch assembly in a retracted configuration, according to an exemplary embodiment.

FIG. 7 is a side view of the frame assembly of FIG. 6 in the first position with the inertial latch assembly in an engagement configuration, according to an exemplary embodiment.

FIG. 8 is a top view of the inertial latch assembly of FIG. 6 in the retracted configuration, according to an exemplary embodiment.

FIG. 9 is a top view of the inertial latch assembly of FIG. 6 in a partially extended configuration, according to an exemplary embodiment.

FIG. 10 is a top view of the inertial latch assembly of FIG. 6 in the engagement configuration, according to an exemplary embodiment.

FIG. 11 is a front perspective view of a linear inertial latch of the inertial latch assembly of FIG. 6 in the retracted configuration, according to an exemplary embodiment.

FIG. 12 is a front perspective view of the linear inertial latch of FIG. 11 in the engagement configuration, according to an exemplary embodiment.

FIG. 13 is a front perspective view of a lower body of the linear inertial latch of FIG. 11, according to an exemplary embodiment.

FIG. 14 is a front perspective view of a portion of the linear inertial latch of FIG. 11, according to an exemplary embodiment.

FIG. 15 is a front perspective view of a pin of the linear inertial latch of FIG. 11, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

According to an exemplary embodiment, a vehicle seat includes a linear inertial latch to prevent unintended movement of a moving portion of the vehicle seat relative to a stationary portion of the vehicle when an acceleration of the inertial latch is greater than or equal to an acceleration threshold of the inertial latch. In some embodiments, the linear inertial latch is provided as a modular kit for converting a non-latched vehicle seat into the vehicle seat with the inertial latch. Advantageously, such a modular kit may provide such movement prevention to the vehicle seat without requiring a replacement of a vehicle seat. The modular kit may include inertial latches and/or latch brackets that are configured to couple to the existing non-latched vehicle seat and/or the vehicle.

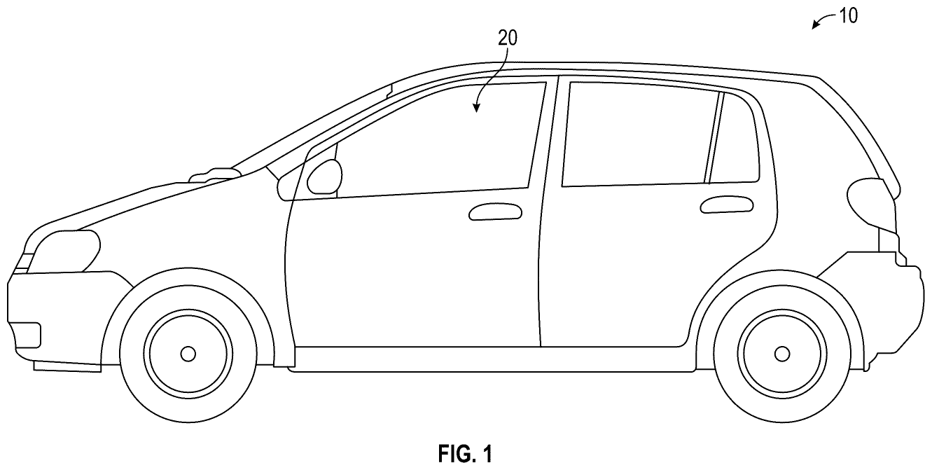

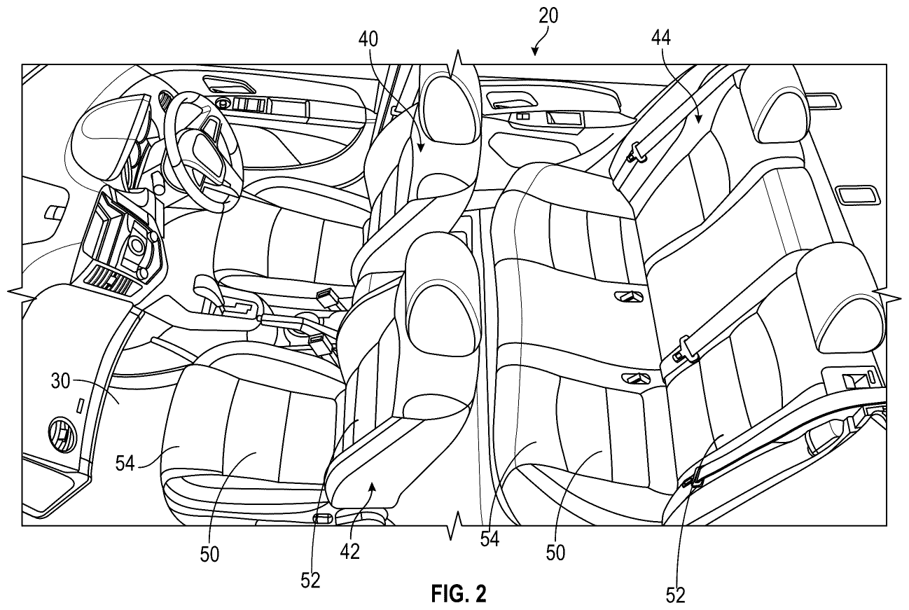

As shown in FIGS. 1 and 2, a vehicle 10 includes an interior cabin, shown as passenger cabin 20. In one embodiment, the vehicle 10 is configured as an on-road vehicle such as a sedan, a sport utility vehicle (“SUV”), a pickup truck, a van, or still another type of passenger vehicle. In other embodiments, the vehicle 10 is configured as another type of on-road vehicle such as a semi-truck, a bus, or the like. In still other embodiments, the vehicle 10 is configured as an off-road vehicle such as, an off-road SUV, construction machinery, farming machinery, or the like.

As shown in FIG. 2, the passenger cabin 20 includes a support surface, shown as cabin floor 30, that supports one or more seating assemblies, shown as seats 40, including one or more first seating assemblies, shown as front seats 42, and one or more second seating assemblies, shown as rear seats 44. In some embodiments, the front seats 42 are different than the rear seats 44. By way of example, the front seats 42 may be individual seats (e.g., operator seats, separated seats, etc.) and the rear seats 44 may be configured as a 60-40 rear seat where the rear seats 44 are split into a first of the rear seats 44 occupying about 60% of a space of the rear seats 44 and a second of the rear seats 44 occupying about 40% of the space of the rear seats 44. The first of the rear seats 44 and the second of the rear seats 44 may be independently folded (e.g., a back rest of the rear seats 44 may be folded forward, each of the rear seats 44 may be folded forward, etc.) to provide additional space in a storage compartment (e.g., a trunk, etc.) of the vehicle 10. As another example, the passenger cabin 20 may include a single of the rear seats 44 (e.g., a bench seat, etc.). In other embodiments, the front seats 42 and the rear seats 44 are the same or utilize similar components (e.g., to facilitate increased scaling for manufacturing and, therefore, a reduction in production costs). In some embodiments, the passenger cabin 20 does not include the rear seats 44. In some embodiments, the passenger cabin 20 only includes a single of the front seat 42.

As shown in FIGS. 2-7, each of the seats 40 includes a bottom cushion, shown as bottom seat cushion 50, configured to support a bottom (e.g., a buttocks, etc.) of an occupant (e.g., when the occupant is occupying the seat 40, etc.), a back cushion, shown as back seat cushion 52, configured to support a back (e.g., a dorsum, etc.) of the occupant, and a framing assembly (e.g., a skeleton, a frame, etc.), shown as frame assembly 100, configured to support the bottom seat cushion 50 and the back seat cushion 52. In some embodiments, the bottom seat cushion 50 includes a front cushion, shown as front cushion 54, supported by the frame assembly 100 and configured to support a thigh portion (e.g., a section of the body at the back of the thighs, etc.) of the occupant.

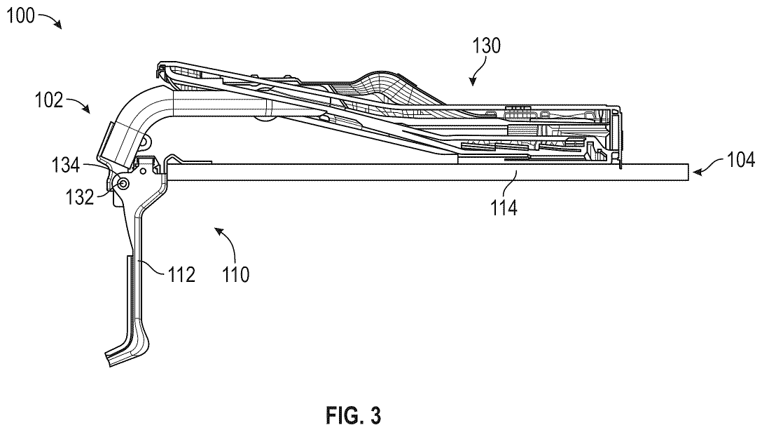

According to the exemplary embodiment shown in FIGS. 3-7, the seat 40 is configured as a foldable seat (e.g., a foldable bench seat, a 60-40 seat, etc.). In some embodiments, the seat 40 is configured as a foldable rear seat. Such a foldable seat may provide enhanced vehicle flexibility for an operator of a vehicle. For example, the foldable seat may allow for the operator to position the foldable seat in a base position to support additional occupants in the vehicle or a stowed position to increase a capacity of a storage compartment of the vehicle. According to an exemplary embodiment, the foldable seat includes a moving portion (e.g., a folding portion, etc.) pivotably coupled to a stationary portion (e.g., a base portion, a non-folding portion, a fixed portion, etc.) of the foldable seat. An orientation of the moving portion may be adjusted relative to the stationary portion to position the foldable rear seat between a plurality of positions or orientations. In other embodiments, the foldable seat includes a moving portion pivotably coupled to a stationary portion of the vehicle 10 (e.g., the cabin floor 30, etc.) and an orientation of the moving portion may be adjusted relative to the stationary portion of the vehicle 10 to position the foldable seat between the plurality of positions or orientations.

As shown in FIGS. 3-7, the frame assembly 100 includes (i) a first frame portion (e.g., a stationary portion, a stationary frame portion, etc.), shown as base frame 110, configured to fixedly couple to a portion of the vehicle 10 (e.g., the cabin floor 30), and (ii) a second frame portion (e.g., a moving portion, a moving frame portion, etc.), shown as seat frame 130, pivotably coupled to the base frame 110 and configured to support the bottom seat cushion 50. In some embodiments, the seat frame 130 is configured to support the back seat cushion 52 (e.g., in addition to supporting the bottom seat cushion 50, etc.). As shown in FIGS. 3-7, the frame assembly 100 includes a first end (e.g., a forward end, a front section, etc.), shown as front end 102, and an opposing second end (e.g., a rearward end, a rear section, etc.), shown as rear end 104, positioned rearward of the front end 102 relative to the direction of travel of the vehicle 10. In other embodiments, the frame assembly 100 does not include the base frame 110 and the base frame 110 is included as a portion of the cabin floor 30 that supports the seat 40.

As shown in FIGS. 3-7, the base frame 110 includes (i) a vertical portion, shown as vertical member 112, configured to couple to the cabin floor 30 (e.g., proximate a foot well positioned forward of the frame assembly 100, etc.) and (ii) a horizontal portion, shown as horizontal member 114, coupled to the vertical member and configured to couple to the cabin floor 30 (e.g., proximate a storage compartment portion of the cabin floor 30, etc.). In some embodiments, the horizontal member 114 is positioned substantially perpendicular to the vertical member 112.

As shown in FIGS. 3-7, the seat frame 130 is pivotably coupled to the base frame 110 along an axis (e.g., pivot, hinge, turning point, etc.), shown as pivot axis 132. The seat frame 130 and the base frame 110 are pivotably coupled about the pivot axis 132 by a coupler (e.g., a pin, a bolt, a shaft, etc.), shown as pivot pin 134, extending through an aperture in the seat frame 130 and an aperture in the vertical member 112 of the base frame 110. In other embodiments, the seat frame 130 and the base frame 110 are rotatably coupled about the pivot axis 132 by another pivoting mechanism (e.g., a four-bar linkage, a gear set, etc.).

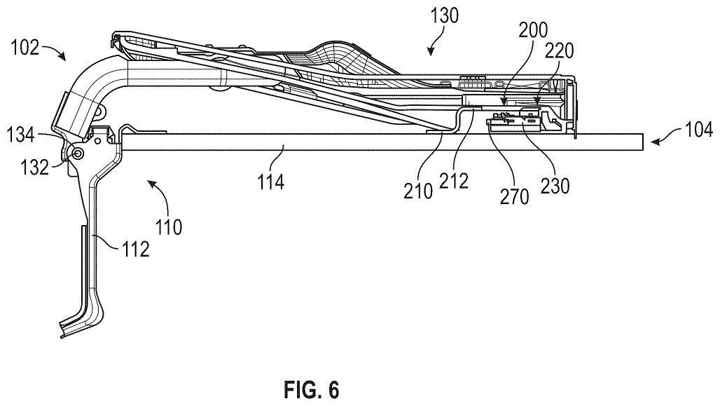

As shown in FIGS. 3 and 6, a lower surface the seat frame 130 is supported by (e.g., rests on, etc.) an upper surface of the horizontal member 114 of the base frame 110 when the seat 40 is in a first position (e.g., a base position, a seating orientation, etc.). In other embodiments, the seat frame 130 is otherwise supported when the seat 40 is in the first position (e.g., supported by the cabin floor 30, etc.).

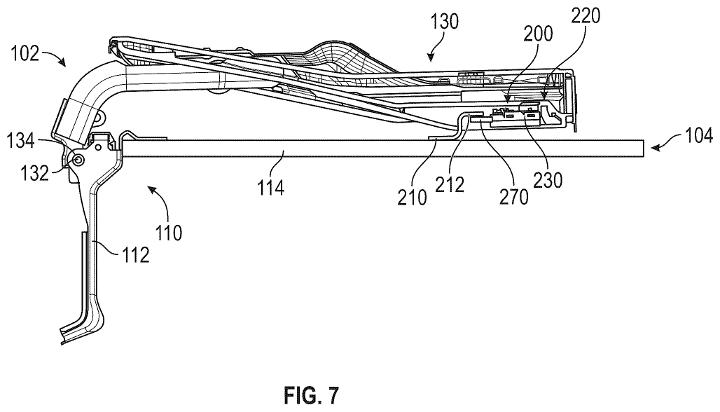

As shown in FIGS. 6 and 7, the frame assembly 100 includes an inertial latch system (e.g., a linear inertial latch assembly, an inertial latch mechanism, an inertial latch kit, etc.), shown as inertial latch assembly 200, configured to secure the seat frame 130 to the base frame 110 to prevent the seat frame 130 from pivoting relative to the base frame 110 when an acceleration of the inertial latch assembly 200 is greater than or equal to an acceleration threshold of the inertial latch assembly 200. For example, the inertial latch assembly 200 may couple the seat frame 130 to the base frame 110 at a location proximate the rear end 104 of the frame assembly 100 when the acceleration of the vehicle 10 is greater than or equal to the acceleration threshold and may release the seat frame 130 from the base frame 110 at the location proximate the rear end 104 of the frame assembly 100 when the acceleration of the vehicle 10 is less than the acceleration threshold. In other embodiments, the inertial latch assembly 200 is configured to secure a different moving component of an assembly to a different stationary component of the assembly (e.g., a door to a door frame, a moving portion to a stationary portion of a mechanical linkage, etc.) when an acceleration of the inertial latch assembly 200 is greater than or equal to the acceleration threshold of the inertial latch assembly 200.

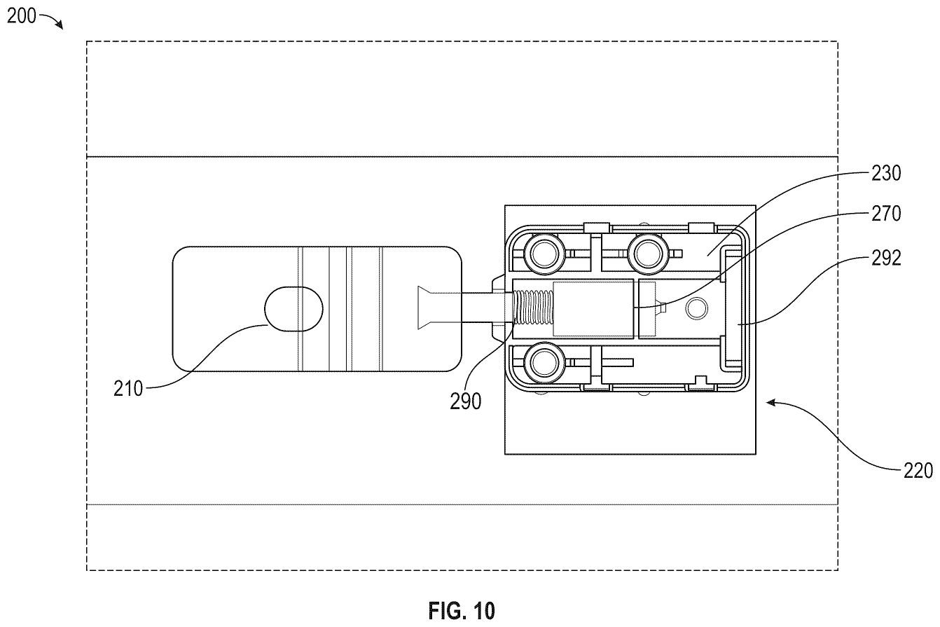

As shown in FIGS. 6-12, the inertial latch assembly 200 includes (i) a bracket (e.g., a ledge, a catch, a retainer, etc.), shown as latch bracket 210, coupled to the base frame 110, and (ii) an inertial latch (e.g., an inertial latch mechanism, an inertial latch device, etc.), shown as linear inertial latch 220, coupled to the seat frame 130. In other embodiments, the latch bracket 210 is coupled to the seat frame 130 and the linear inertial latch 220 is coupled to the base frame 110. According to an exemplary embodiment, the linear inertial latch 220 is configured to (i) engage the latch bracket 210 when (a) the seat 40 is in the first position and (b) the acceleration of the linear inertial latch 220 is greater than or equal to the acceleration threshold to secure the seat frame 130 to the base frame 110 and prevent the seat frame 130 from pivoting relative to the base frame 110 and (ii) disengage from the latch bracket 210 when the acceleration of the linear inertial latch 220 is less than the acceleration threshold to allow the seat frame 130 to pivot relative to the base frame 110.

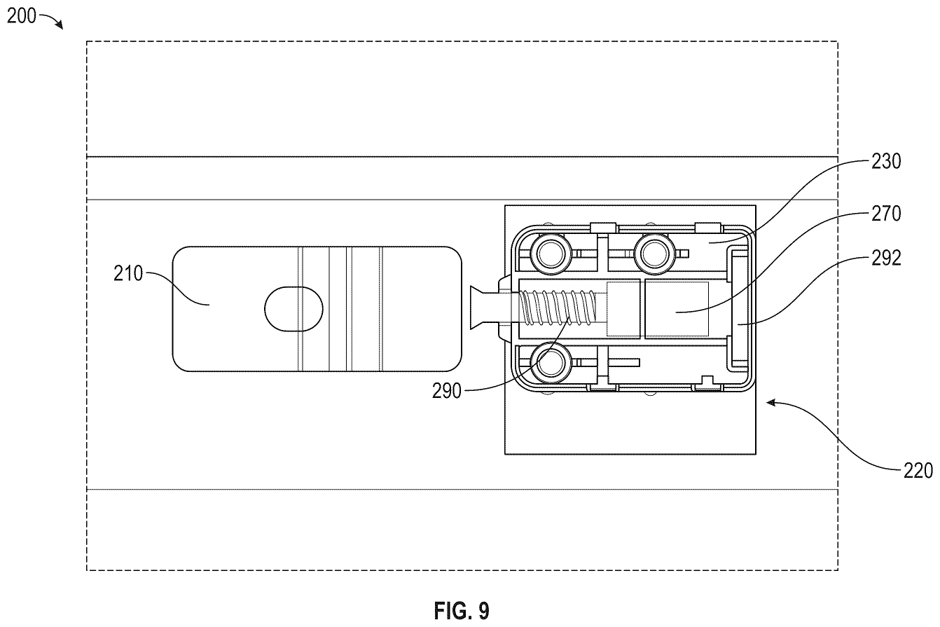

As shown in FIGS. 6, 8, and 11, the linear inertial latch 220 is in a retracted configuration where the linear inertial latch 220 does not engage the latch bracket 210 when the acceleration of the linear inertial latch 220 is less than the acceleration threshold. In some embodiments, the linear inertial latch 220 is in the retracted configuration when the acceleration of the linear inertial latch 220 is zero. As shown in FIG. 9, the linear inertial latch is in a partially extended configuration where the linear inertial latch 220 does not engage the latch bracket 210 when the acceleration of the linear inertial latch 220 is greater than a minimum acceleration of the linear inertial latch 220 that places the linear inertial latch 220 in the retracted configuration but is less than the acceleration threshold. In some embodiments, the linear inertial latch 220 is in the partially extended configuration when the acceleration of the linear inertial latch 220 is greater than zero but is less than the acceleration threshold. As shown in FIGS. 7, 10, and 12, the linear inertial latch 220 is in an engagement configuration when the acceleration of the linear inertial latch 220 is greater than or equal to the acceleration threshold. When the linear inertial latch 220 is in the engagement configuration and the seat 40 is in the first position, the linear inertial latch 220 may engage the latch bracket 210 to prevent the seat frame 130 from pivoting about the pivot axis 132.

As used herein, the term “acceleration” of the linear inertial latch 220 refers to a rate of change of a velocity of the linear inertial latch 220 with respect to time. The acceleration of the linear inertial latch 220 is a vector quantity, meaning that it has both a magnitude and a direction. The acceleration of the linear inertial latch 220 may be a change in speed and/or direction of the linear inertial latch 220. As used herein, the term “acceleration threshold” of the linear inertial latch 220 refers to a minimum acceleration of the linear inertial latch 220 that places the linear inertial latch 220 in the engagement configuration. The acceleration threshold of the linear inertial latch 220 also is a vector quantity with a magnitude and a direction. The acceleration of the linear inertial latch 220 may be greater than or equal to the acceleration threshold of the linear inertial latch 220 when the magnitude of the acceleration in the direction of the acceleration threshold is greater than or equal to the magnitude of the acceleration threshold.

As shown in FIGS. 6 and 7, the latch bracket 210 includes a retainer (e.g., engagement surface, retaining surface, etc.), shown as engagement ledge 212, configured to engage the linear inertial latch 220 when the seat 40 is in the first position and the linear inertial latch 220 is in the engagement configuration. The engagement ledge 212 of the latch bracket 210 extends above the upper surface of the base frame 110. More specifically, the latch bracket 210 is configured as a z-bracket that includes a first leg that is coupled to the upper surface of the base frame 110 and a second leg defining the engagement ledge 212 spaced above first leg that engages the linear inertial latch 220 when the linear inertial latch 220 is in the engagement configuration and when the seat 40 is in the first position. The latch bracket 210 may extend above the upper surface of the base frame 110 into a seat frame cavity defined by the lower surface of the seat frame 130 when the seat 40 is in the first position such that the engagement ledge 212 of the latch bracket 210 is aligned to be engaged by the linear inertial latch 220 when the seat 40 is in the first position. In other embodiments, the engagement ledge 212 of the linear inertial latch 220 is positioned below the upper surface of the base frame 110. The linear inertial latch 220 may extend below the lower surface of the seat frame 130 into a base frame cavity defined by the upper surface of the base frame 110 when the seat 40 is in the first position such that the linear inertial latch 220 is aligned to engage the engagement ledge 212 of the latch bracket 210 when the seat 40 is in the first position. In various embodiments, the engagement ledge 212 of the latch bracket 210 extends above the upper surface of the base frame 110 and the linear inertial latch 220 extends below the lower surface of the seat frame 130. The linear inertial latch 220 may extend into the base frame cavity defined by the base frame 110 and the latch bracket 210 may extend into the seat frame cavity defined by the seat frame 130 when the seat 40 is in the first position such that the linear inertial latch 220 is aligned to engage the engagement ledge 212 of the latch bracket 210.

As shown in FIGS. 6-12, the linear inertial latch 220 includes (i) a body (e.g., a case, a housing, etc.), shown as latch housing 230, coupled to the seat frame 130, (ii) a latching mechanism, (e.g., a latch bolt, etc.), shown as latch pin 270, at least partially disposed within the latch housing 230, slidably coupled to the latch housing 230, and configured to engage the engagement ledge 212 of the latch bracket 210 when the linear inertial latch 220 is in the engagement configuration, and (iii) a biasing element (e.g., an elastic element, a spring, etc.), shown as compression spring 290, disposed within the latch housing 230 and in engagement with the latch pin 270. The compression spring 290 is configured to bias the latch pin 270 toward the retracted configuration and prevent the latch pin 270 from being in the engagement configuration when the acceleration of the linear inertial latch 220 is less than the acceleration threshold. The compression spring 290 is configured to allow the latch pin 270 to be move into the engagement configuration when the acceleration of the linear inertial latch 220 is greater than the acceleration threshold.

The compression spring 290 is configured to provide a biasing force (e.g., a spring force, a compressive force, etc.) to the latch pin 270 that is sufficient to prevent (e.g., inhibit, etc.) the latch pin 270 from sliding (e.g., extending outward from the latch housing 230, etc.) into an engagement position to place the linear inertial latch 220 in the engagement configuration unless the acceleration of the linear inertial latch 220 is greater than or equal to the acceleration threshold. When (e.g., responsive to, etc.) the acceleration of the linear inertial latch 220 is greater than or equal to the acceleration threshold, the latch pin 270 may overcome the spring force provided by the compression spring 290 and move into the engagement position by compressing the compression spring 290. In other embodiments, the linear inertial latch 220 includes a different elastic or biasing element than the compression spring 290 configured to prevent the latch pin 270 from sliding into the engagement position when the acceleration of the linear inertial latch 220 is less than the acceleration threshold (e.g., an extension spring, a constant force spring, an elastomer element, etc.).

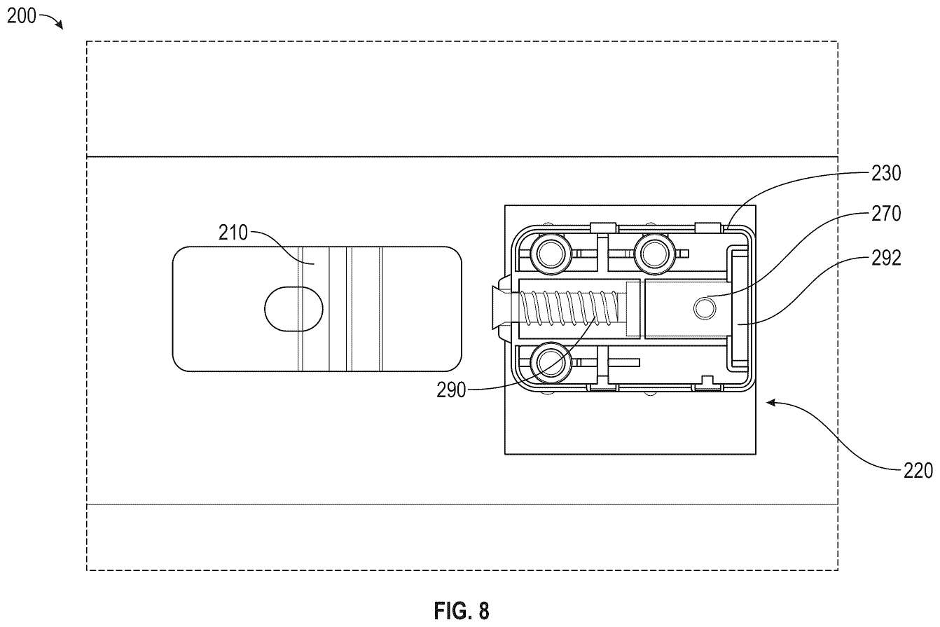

According to the exemplary embodiment shown in FIGS. 8-10 and 14, the linear inertial latch 220 includes a damper (e.g., a shock absorber, a stabilizer, a suppressor, etc.), shown as pin damper 292, disposed in the latch housing 230 between the latch housing 230 and the latch pin 270 when the linear inertial latch 220 is in the retracted configuration. The compression spring 290 may press the latch pin 270 against the pin damper 292 when the acceleration of the linear inertial latch 220 is less than the acceleration threshold to prevent motion of the latch pin 270 relative to the latch housing 230 that could otherwise result in the latch pin 270 rattling against the latch housing 230 and causing a noise that may be disruptive to the operator and/or the occupants of the vehicle 10. In some embodiments, the pin damper 292 is formed out of foam, rubber, or a different elastomer. In other embodiments, the linear inertial latch 220 does not include the pin damper 292 and any rattling between the latch pin 270 and the latch housing 230 is prevented using different methods (e.g., the profile of the pin aperture 252, etc.).

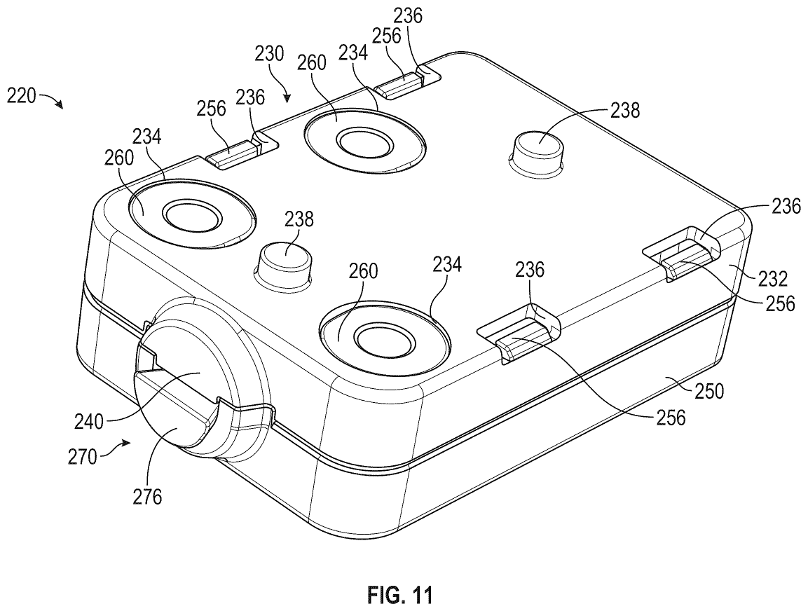

As shown in FIGS. 11-13, the latch housing 230 includes a top portion, shown as upper housing 232, and a lower portion, shown as lower housing 250, coupled to the upper housing 232. When the upper housing 232 is coupled to the lower housing 250, the upper housing 232 and the lower housing 250 cooperatively define an opening (e.g., a housing opening, a cavity, a chamber. etc.), shown as pin slot 251, configured to receive the compression spring 290 and the portion of the latch pin 270.

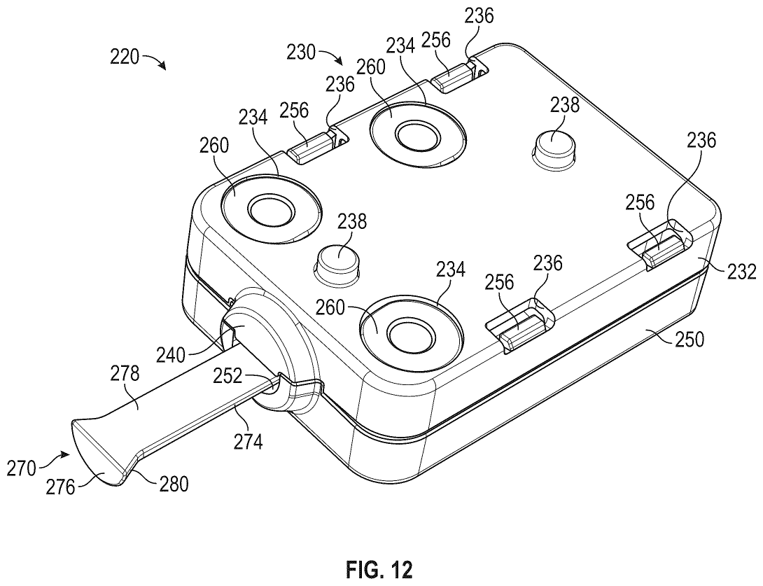

As shown in FIGS. 11 and 12, the upper housing 232 defines (i) a plurality of apertures, shown as upper fastener apertures 234, extending through the upper housing 232 and (ii) a plurality of openings, shown as clasp openings 236, extending through the upper housing 232. In other embodiments, the upper housing 232 does not define the upper fastener aperture 234 (e.g., when the upper housing 232 is coupled to the lower housing 250 without using fasteners, etc.) and/or the clasp openings 236 (e.g., when the upper housing 232 is coupled to the lower housing 250 without using clasps, etc.).

As shown in FIGS. 11 and 12, the upper housing 232 includes a plurality of posts (e.g., extrusions, protrusions, etc.), shown as mounting posts 238, configured to engage the seat frame 130 to couple the latch housing 230 to the seat frame 130. In other embodiments, the mounting posts 238 may be configured to engage the base frame 110 to couple the latch housing 230 to the base frame 110. In still other embodiments, the upper housing 232 does not include the mounting posts 238 and the upper housing 232 is coupled to the seat frame 130 and/or the base frame 110 using an alternate method (e.g., fasteners, adhesive, etc.).

As shown in FIGS. 11 and 12, the upper housing 232 includes a stop (e.g., a limiting surface, a restraint surface, etc.), shown as hard stop 240, configured to limit movement of the latch pin 270. The hard stop 240 may limit the motion of the latch pin 270 to an extended position (e.g., a maximum extension position, etc.) when the acceleration of the linear inertial latch 220 is greater than the acceleration threshold. In some embodiments, the compression spring 290 is positioned between a portion of the latch pin 270 and the hard stop 240 such that the spring force provided by the compression spring 290 on the latch pin 270 is generated by a compression of the compression spring 290 between the hard stop 240 and the latch pin 270. In other embodiments, the lower housing 250 includes the hard stop 240.

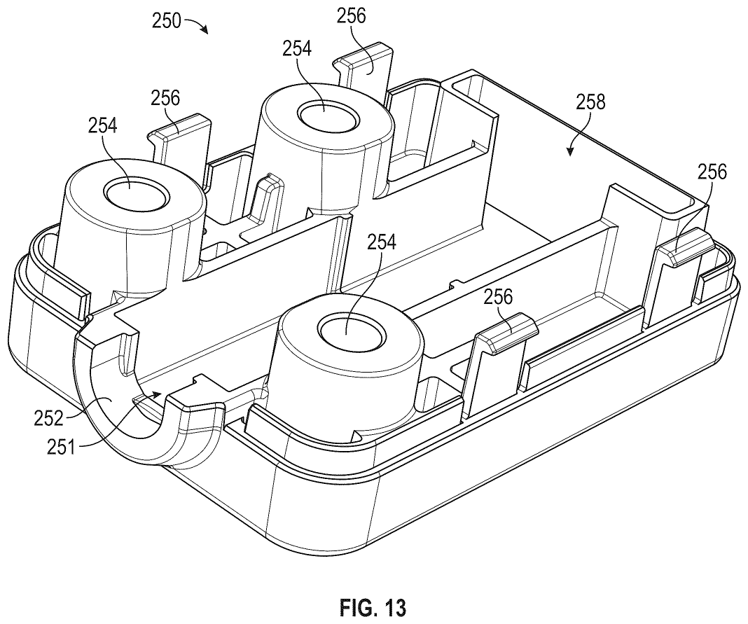

As shown in FIGS. 12 and 13, the lower housing 250 defines an aperture, shown as pin aperture 252, extending through the lower housing 250, configured to provide access through the lower housing 250 into the pin slot 251 between the upper housing 232 and the lower housing 250, and configured to receive the latch pin 270. The latch pin 270 extends through the pin aperture 252. The pin aperture 252 may be configured to engage the latch pin 270 when the latch pin 270 is in the retracted position to prevent motion of the latch pin 270 relative to the latch housing 230 that could result in the latch pin 270 rattling against the latch housing 230 and causing a noise that may be disruptive to the operator and/or the occupants of the vehicle 10. In some embodiments, the pin aperture 252 includes an engagement element extending into an opening defined by the pin aperture 252 configured to contact the latch pin 270 when the latch pin 270 is in the retracted position to prevent rattling of the latch pin 270 against the latch housing 230. In other embodiments, the upper housing 232 defines the pin aperture 252.

As shown in FIGS. 11-13, a profile of the hard stop 240 and the pin aperture 252 is configured to match a profile of a portion of the latch pin 270 that extends through the pin aperture 252. According to the exemplary embodiment shown in FIGS. 11-13, the profile of the portion of the latch pin 270 that extends through the pin aperture 252 is a half-circle and the profile of the pin aperture 252 is also a half-circle. In other embodiments, the profile of the portion of the latch pin 270 that extends through the pin aperture 252 is a different shape (e.g., rectangular, circular, ovular, triangular, hexagonal, etc.) and the profile of the pin aperture 252 is also the different shape. In still other embodiments, the profile of the pin aperture 252 is not configured to match the profile of the portion of the latch pin 270 that extends through the pin aperture 252 (e.g., the profile of the pin aperture 252 is circular and the profile of the portion of the latch pin 270 that extends through the pin aperture 252 is square, etc.).

As shown in FIGS. 11-13, the lower housing 250 includes a plurality of protrusions, shown as posts 260, that define a plurality of apertures, shown as lower fastener apertures 254, extending through the lower housing 250 and configured to align with one of the upper fastener apertures 234 when the lower housing 250 is coupled to the upper housing 232. Each of the lower fastener apertures 254 aligns with one of the upper fastener apertures 234 to receive a fastener (e.g., a bolt, a screw, a pin, etc.) to couple the latch housing 230 to the seat frame 130 and/or the upper housing 232 to the lower housing 250.

As shown in FIGS. 11-13, the lower housing 250 includes a plurality of clasps (e.g., latches, fasteners, retainers, etc.), shown as lower clasps 256, configured to align with the clasp openings 236 when the lower housing 250 is coupled to the upper housing 232. As shown in FIGS. 11 and 12, each of the lower clasps 256 extends through one of the clasp openings 236 and engage the one of the clasp openings 236 to couple the lower housing 250 to the upper housing 232. For example, the lower clasps 256 may be configured to snap fit into the clasp openings 236 to couple the lower housing 250 to the upper housing 232 and lower clasps 256 may be disengaged from the clasp openings 236 to release the lower housing 250 from the upper housing 232. In other embodiments, the lower housing 250 does not include the lower clasps 256 and the lower housing 250 is coupled to the upper housing 232 using an alternate method (e.g., coupled by independent fasteners, coupled by the fasteners extending through the lower fastener aperture 254 and the upper fastener apertures 234, etc.).

According to the exemplary embodiment shown in FIG. 13, the lower housing 250 defines a slot, shown as damper opening 258, positioned at a back end of the pin slot 251 that is configured to receive the pin damper 292. The pin damper 292 may be disposed within the damper opening 258 to retain the pin damper 292 in a position such that the latch pin 270 contacts the pin damper 292 when the latch pin 270 is in the retracted position and the latch pin 270 does not contact the pin damper 292 when the latch pin 270 is extended away from the retracted position (e.g., in the extended position, etc.).

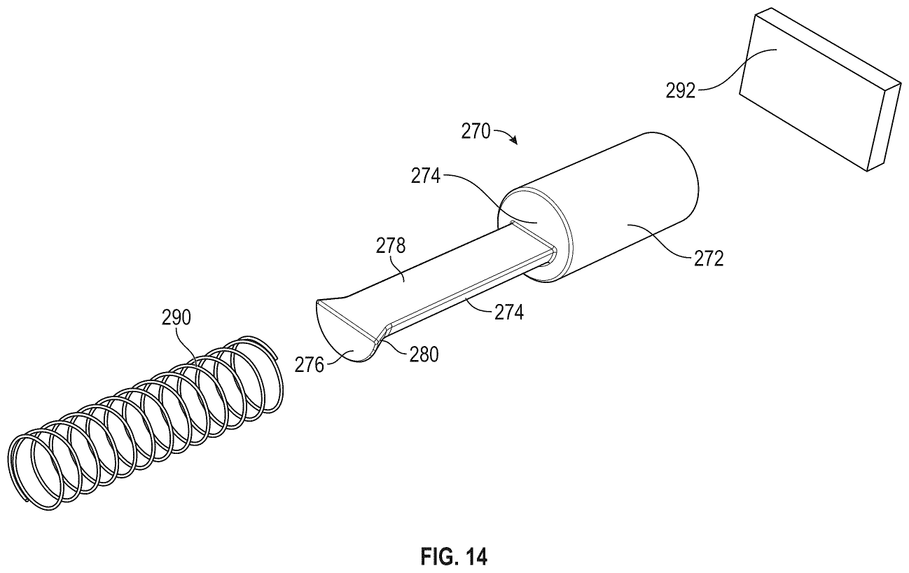

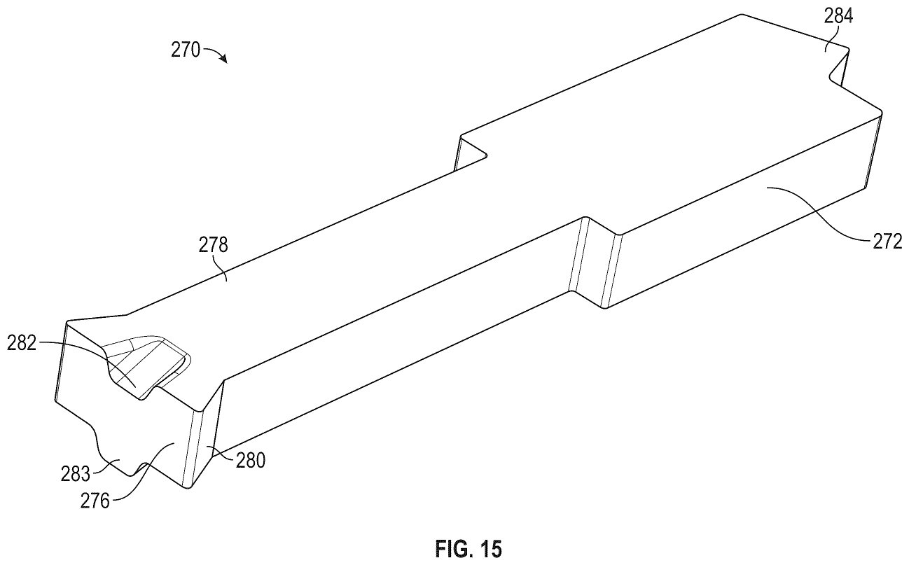

As shown in FIGS. 14 and 15, the latch pin 270 includes (i) a body (e.g., a weighted portion, etc.), shown as pin body 272, disposed within the pin slot 251 between the upper housing 232 and the lower housing 250 and configured to interface with the compression spring 290, (ii) a mandrel (e.g., an extension portion, etc.), shown as pin mandrel 274, coupled to the pin body 272 at a first end of the pin mandrel 274, extending from the pin body 272, and extending through the pin aperture 252 of the lower housing 250, and (iii) a head (e.g., a distal end, etc.), shown as pin head 276, coupled to the pin mandrel 274 at a second end of the pin mandrel 274 opposite the first end of the pin mandrel 274. In some embodiments, the pin body 272, the pin mandrel 274, and the pin head 276 are integrally formed (e.g., form a single weldment, welded, a single cast or forged part, a single stamped part, etc.).

According to an exemplary embodiment, a profile of the pin body 272 is larger than the profile of the pin aperture 252 such that the latch pin 270 is not able to fully drift (e.g., pass through, etc.) the pin aperture 252. As shown in FIGS. 11 and 12, a profile of the pin head 276 is larger than the profile of the pin aperture 252 of the lower housing 250 such that the latch pin 270 is not able to fully drift through the pin aperture 252. In other embodiments, the profile of the pin head 276 is smaller than or the same size as the profile of the pin aperture 252.

In some embodiments, the pin mandrel 274 is configured to engage with the compression spring 290 such that the compression spring 290 is disposed around an outside surface of the pin mandrel 274 between the pin body 272 and the pin head 276. When the compression spring 290 is positioned around the pin mandrel 274, the pin body 272 may compress the compression spring 290 against the hard stop 240 of the upper housing 232 as the latch pin 270 moves toward the extended position. In other embodiments, the pin mandrel 274 is not configured to receive the compression spring 290 (e.g., when the elastic element is not the compression spring 290, etc.).

As shown in FIGS. 12, 14, and 15, the pin mandrel 274 and the pin head 276 cooperatively define a pin engagement surface 278 configured to engage the engagement ledge 212 of the latch bracket 210 when the seat 40 is in the first position and the latch pin 270 is in the engagement position. In other embodiments, the pin mandrel 274 does not define the pin engagement surface 278 (e.g., when the pin head 276 engages the engagement ledge 212 and the pin mandrel 274 does not engage the engagement ledge 212, etc.).

As shown in FIGS. 12, 14, and 15, the latch pin 270 includes an interface (e.g., a transition portion, etc.), shown as pin head interface 280, between the pin mandrel 274 and the pin head 276. The pin head interface 280 is tapered between an outside surface of the pin mandrel 274 and an outside surface of the pin head 276. The pin head interface 280 may engage the pin aperture 252 of the lower housing 250 when the latch pin 270 is in the retracted position to reduce rattling between the latch pin 270 and the latch housing 230. In other embodiments, the pin head interface 280 is not tapered (e.g., when there is a 90 degree interface between the pin head 276 and the pin mandrel 274, etc.).

As shown in FIG. 15, a first side of the pin head 276 defines a cutout (e.g., a stress relief feature, stress mitigation elements, fatigue reduction features, stress dispersal elements, etc.), shown as notch 282, and an opposing second side of the pin head 276 includes a protrusion, shown as pin retainer 283. The notch 282 and/or the pin retainer 283 may be configured to engage with a portion of the latch housing 230 when the latch pin 270 is in the retracted position and/or a portion of the engagement ledge 212 when the latch pin 270 is in the engaged position (e.g., for alignment purposes, rattle mitigation purposes, etc.).

As shown in FIG. 15, the pin body 272 includes a damper interface (e.g., a damper extrusion, etc.), shown as damper tooth 284, extending from the pin body 272. According to an exemplary embodiment, the damper tooth 284 is configured to engage the pin damper 292 when the latch pin 270 is in the retracted position. The damper tooth 284 may partially penetrate the pin damper 292 when the latch pin 270 is in the retracted position to further prevent motion between the latch pin 270 and the latch housing 230 that could cause rattling of the latch pin 270 within the latch housing 230. In other embodiments, the pin body 272 does not include the damper tooth 284.

As described above, the seat 40 is configured as a foldable seat that provides foldable adjustment to reconfigure the seat 40 from a first or seating orientation configured to support an occupant and/or an object on the bottom seat cushion 50 to a second or stowed orientation configured to increase a capacity of a storage compartment (e.g., a trunk, etc.) of the vehicle 10. To provide the stowed orientation, the seat frame 130 may be pivoted forward about the front end 102 thereof toward the front seats 42. The seat 40 includes the inertial latch assembly 200 configured to secure the seat 40 in the first position when an acceleration of the linear inertial latch 220 is above an acceleration threshold.

As shown in FIGS. 3 and 6, the frame assembly 100 can be moved, manipulated, reconfigured, etc. into a base orientation (e.g., neutral position, starting position, nominal position, etc.) with the seat frame 130 in a standard, substantially horizontal orientation relative to the base frame 110 and supported by the top surface of the base frame 110. In some embodiments, the frame assembly 100 moves to the base orientation when an occupant activates or engages a user interface (e.g., presses a button, pulls a lever, taps a portion of a touch screen, etc.). In other embodiments, the occupant may manually move the frame assembly 100 to the first position (e.g., by applying forces to different components of the frame assembly 100, etc.).

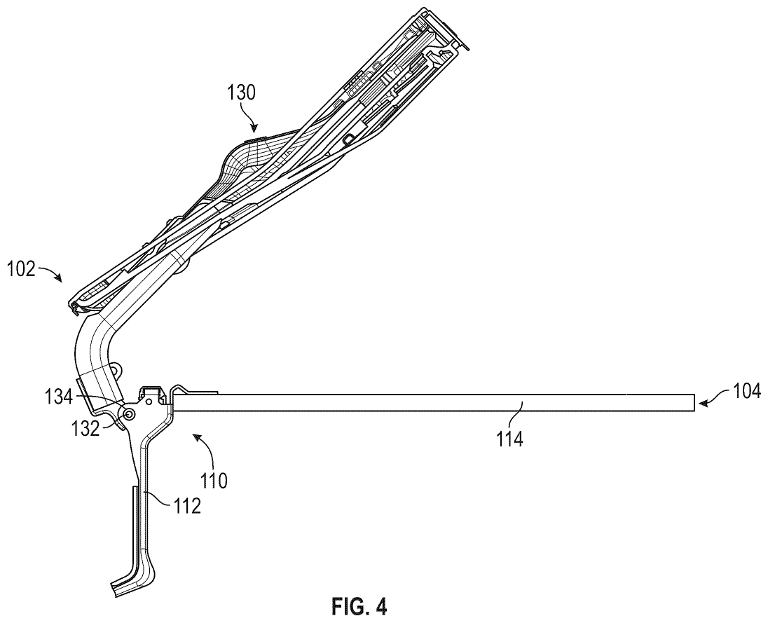

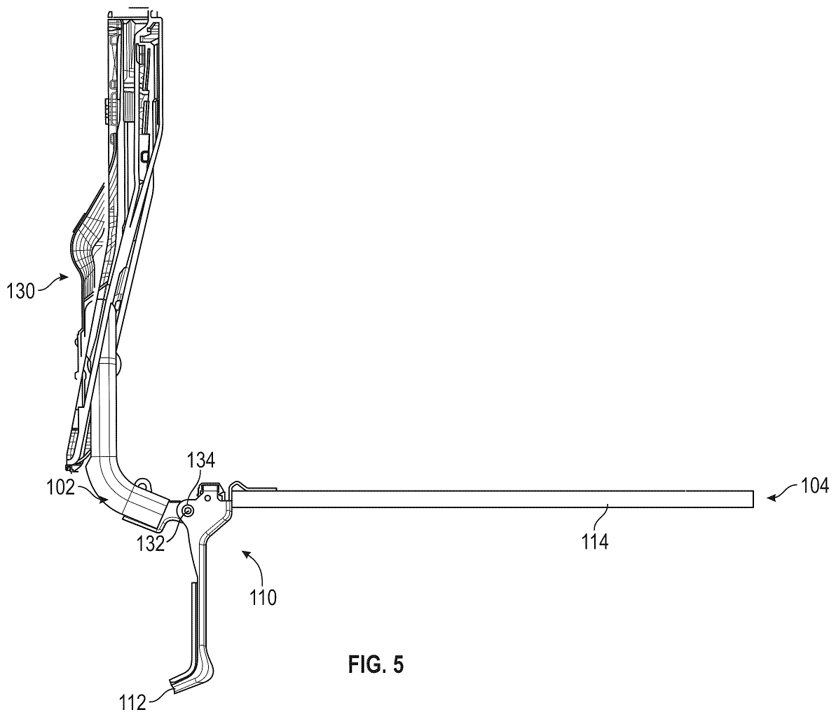

In operation, the seat frame 130 facilitates providing adjustment between the base orientation and the stowed orientation. For example, as shown in FIGS. 4 and 5, the frame assembly 100 can be selectively reconfigurable into a raised orientation and a stowed orientation, respectively, by rotating the seat frame 130 relative to the base frame 110 about the pivot axis 132 from the first position so that the seat frame 130 is angled forward. The stowed orientation may increase the storage capacity of the storage compartment of the vehicle 10 by increasing a volume of the storage compartment to include the space occupied by the seat frame 130 in the base orientation, which may allow for the operator of the vehicle 10 to store more objects in the storage compartment of the vehicle 10. In some embodiments, the seat frame 130 may be rotated about the pivot axis 132 manually (e.g., manually adjustable, by hand, etc.) by applying a force to the seat frame 130. In some embodiments, the frame assembly 100 includes a lock (e.g., safety lock, rachet, etc.) that must be released prior to rotating the seat frame 130. In other embodiments, the seat frame 130 rotates about the pivot axis 132 through the use of a motor (e.g., electronically adjustable, electromechanically adjustable etc.). In some embodiments, the seat frame 130 rotates about the pivot axis 132 when an occupant activates or engages a user interface (e.g., pressing a first button to rotate the seat frame 130 in a first direction, pressing a second bottom to rotate the seat frame 130 in a second direction, etc.).

In operation, the frame assembly 100 without the inertial latch assembly 200 may be unintendedly reconfigured into the raised orientation or the stowed orientation when the seat frame 130 is rotated forward relative to the base frame 110 about the pivot axis 132 due to a rearward acceleration (e.g., a change of velocity, a deceleration, etc.) of the vehicle 10 and the base frame 110 (e.g., an acceleration toward the rear end 104 of the frame assembly 100, a rearward acceleration of the vehicle 10, a front collision, a hard deceleration, etc.). Since the seat frame 130 is pivotably coupled to the base frame 110, the seat frame 130 will rotate forward about the pivot axis 132 due to the rearward acceleration of the vehicle 10 until a force is applied on the seat frame 130 that overcomes an inertia of the seat frame 130 (e.g., a force that causes the seat frame 130 to experience the same acceleration as the vehicle and the base frame 110, etc.). If the base frame 110 does not apply a force on the seat frame 130 that overcomes the inertia of the seat frame 130, the seat frame 130 will rotate forward about the pivot axis 132 until the force that overcomes the inertia is applied (e.g., by the seat frame 130, after contacting another of the seats 40 of the vehicle 10, after contacting an occupant of the vehicle 10, etc.). In some embodiments, during the change in velocity of the vehicle 10, the inertia of the seat frame 130 may overcome a locking force of the lock of the frame assembly 100 without the inertial latch assembly 200, resulting in the unintended rotation of the seat frame 130 about the pivot axis 132. In other embodiments, for the frame assembly 100 without the inertial latch assembly 200, during the change in velocity of the vehicle 10, the inertia of the seat frame 130 may overcome a torque resistance of the motor configured to rotate the seat frame 130 about the pivot axis 132, resulting in the unintended rotation of the seat frame 130 about the pivot axis 132.

However, when the frame assembly 100 includes the inertial latch assembly 200, the inertial latch assembly 200 can prevent unintended pivoting of the seat frame 130 from the base orientation into the raised orientation or the stowed orientation due to the rearward acceleration of the vehicle 10. Since the latch pin 270 of the linear inertial latch 220 is slidably coupled to the latch housing 230, the latch pin 270 will slide (e.g., translate, etc.) relative to the latch housing 230 due to the rearward acceleration of the vehicle 10 until a force is applied on the latch pin 270 that overcomes an inertia of the latch pin 270. The movement of the latch pin 270 will compress the compression spring 290, generating a compression force applied by the compression spring 290 on the latch pin 270. If the compression force from the compression spring 290 does not overcome the inertia of the latch pin 270, the latch pin 270 will continue to slide relative to the latch housing 230 toward the engagement position until the compression spring 290 applies the force on the latch pin 270 that overcomes the inertia of the latch pin 270. When the acceleration of the linear inertial latch 220 is greater than the acceleration threshold, the latch pin 270 slides into the engagement position to engage the latch bracket 210 and prevent the seat frame 130 from unintendedly rotating about the pivot axis 132.

The acceleration threshold of the linear inertial latch 220 is the acceleration of the vehicle 10 that allows the latch pin 270 to slide into engagement position where the latch pin 270 can engage the latch bracket 210 and prevent the seat frame 130 from unintendedly rotating about the pivot axis 132 before the force applied by the compression spring 290 on the latch pin 270 overcomes the inertia of the latch pin 270. If the acceleration of the vehicle 10 is below the acceleration threshold, the latch pin 270 will slide forward toward the engagement position, but the force applied by the compression spring 290 on the latch pin 270 will overcome the inertia of the latch pin 270 before the latch pin 270 reaches the engagement position. The force to overcome the inertia of the latch pin 270 may be generated by the compression of the compression spring 290 or by the hard stop 240 of the upper housing 232 through the compression spring 290 once the compression spring 290 reached its solid height (e.g., maximum compression, etc.). Once the inertia of the latch pin 270 has been overcome, the compression force from the compression spring 290 on the latch pin 270 will slide the latch pin 270 back towards the retracted position, which may move the latch pin 270 out of the engagement position and allow for the seat frame 130 to pivot about the pivot axis 132.

In some embodiments, the acceleration threshold of the linear inertial latch 220 is adjustable or tunable by modifying a mass of the latch pin 270. Since the inertia of the latch pin 270 depends on the mass of the latch pin 270, a modification to the mass of the latch pin 270 would modify a required force on the latch pin 270 to overcome the inertia of the latch pin 270 during an acceleration of the vehicle 10 to facilitate reducing or increasing resistance to movement of the latch pin 270 during an acceleration event. For example, if the mass of the latch pin 270 was increased, the acceleration threshold would decrease as smaller accelerations of the linear inertial latch 220 would cause the latch pin 270 to reach the engagement position. As another example, if the mass of the latch pin 270 was decreased, the acceleration threshold would increase as it would take larger accelerations of the linear inertial latch 220 for the latch pin 270 to reach the engagement threshold.

In some embodiments, the mass of the latch pin 270 is modified by modifying the pin body 272. For example, the mass of the latch pin 270 may be modified by changing a material of the pin body 272 (e.g., increasing or decreasing a density of the pin body 272, etc.), changing a shape of the pin body 272 (e.g., increasing or decreasing a volume of the pin body 272, changing a length of the pin body 272, etc.). In other embodiments, the mass of the latch pin 270 is modified by modifying a mass of other components of the latch pin 270 (e.g., the pin mandrel 274, the pin head 276, etc.).

In some embodiments, the acceleration threshold of the linear inertial latch 220 may be changed by modifying a length of the pin mandrel 274. Since the engagement position where the latch pin 270 can engage the latch bracket 210 depends on the length of the pin mandrel 274, a modification to the length of the pin mandrel 274 would modify a distance that the latch pin 270 would need to travel from the retracted position to reach the engagement position. Since the compression force applied on the latch pin 270 by the compression spring 290 depends on a distance that the latch pin 270 compresses the compression spring 290, an increase in the length of the pin mandrel 274 results in a decrease in the acceleration threshold as the latch pin 270 would need to compress the compression spring 290 less to reach the engagement position. A decrease in the length of the pin mandrel 274 results in an increase in the acceleration threshold as the latch pin 270 would need to compress the compression spring 290 more to reach the engagement position. In other embodiments, a length of the pin head 276 is modified to change the acceleration threshold of the linear inertial latch 220.

In some embodiments, the acceleration threshold of the linear inertial latch 220 may be changed by modifying characteristics of the compression spring 290. Since the compression force applied on the latch pin 270 by the compression spring 290 depends on the characteristics of the compression spring 290, a change in the characteristics of the compression spring 290 results in changes to the acceleration threshold. For example, if a spring constant of the compression spring 290 is increased, the compression force applied on the latch pin 270 by the compression spring 290 increases at a faster rate as the latch pin 270 travels from the retracted position toward the engagement position, resulting in an increase in the acceleration threshold as the acceleration must be greater for the inertia of the latch pin 270 to overcome the compression force of the compression spring 290 and reach the engagement position. As another example, if the spring constant of the compression spring is decreased, the compression force applied on the latch pin 270 by the compression spring 290 increases at a slower rate as the latch pin 270 travels from the retracted position toward the engagement position, resulting in a decrease in the acceleration threshold as the acceleration may be lower for the inertia of the latch pin 270 to overcome the compression force of the compression spring 290 and reach the engagement position.

According to an exemplary embodiment, the inertial latch assembly 200 can be manufactured as a modular kit configured to provide a retrofit solution for securing a moving portion of an assembly to a stationary portion of the assembly. In some embodiments, the inertial latch assembly 200 can be manufactured as a modular kit configured to provide a retrofit solution for converting a vehicle seat without an inertial latch to a vehicle seat with an inertial latch. Accordingly, various different inertial latch assemblies 200 can be designed and manufactured to integrate into various different vehicle seats without inertial latches. Therefore, installing the inertial latch assembly 200 into an existing frame assembly of a seat or into an existing frame assembly of a seat and a support surface of a vehicle that includes the seat may provide additional security of the seat provided by the inertial latch assembly 200 without requiring the purchase of a new seat.

In some embodiments, the modular kit of the inertial latch assembly 200 can include multiple configurations of the latch pin 270 and/or multiple configurations of the compression spring 290 to allow for adjustment of the acceleration threshold of the linear inertial latch 220 based on a use of the inertial latch assembly 200. In some embodiments, the modular kit includes a first compression spring 290 with a first spring constant and a second compression spring 290 with a second spring constant to allow for the linear inertial latch 220 to be reconfigurable with a first acceleration threshold or a second acceleration threshold. In some embodiments, the modular kit includes a first latch pin 270 with a first mass and/or a first length and a second latch pin 270 with a second mass and/or a second length to allow for the linear inertial latch 220 to be reconfigurable with a first acceleration threshold or a second acceleration threshold. In various embodiments, the modular kit includes the first compression spring 290, the second compression spring 290, the first latch pin 270, and the second latch pin 270 to allow for the inertial latch to be configured with a first acceleration threshold, a second acceleration threshold, a third acceleration threshold, and a fourth acceleration threshold based on various combinations of the first compression spring 290, the second compression spring 290, the first latch pin 270, and the second latch pin 270. In various embodiments, the modular kit includes any number of latch pins 270 and/or compression springs 290 to provide various acceleration thresholds.

As utilized herein, the terms “approximately,” “about,” “relatively,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Language such as the phrases “at least one of X, Y, and Z” and “at least one of X, Y, or Z,” unless specifically stated otherwise, are understood to convey that an element may be either X; Y; Z; X and Y; X and Z; Y and Z; or X, Y, and Z (i.e., any combination of X, Y, and Z). Thus, such language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the seat 40 and components thereof (e.g., the frame assembly 100, the inertial latch assembly 200, etc.) as shown in the various exemplary embodiments is illustrative only. Additionally, any element disclosed in one embodiment may be incorporated or utilized with any other embodiment disclosed herein.

1. A linear inertial latch assembly for securing a moving portion of a vehicle seat to a stationary portion of the vehicle seat or a vehicle within which the vehicle seat is installed, the linear inertial latch assembly comprising:
a bracket configured to couple to the stationary portion; and
a linear inertial latch configured to couple to the moving portion of the vehicle seat, the linear inertial latch including:
a housing defining an interior chamber and a pin aperture extending through the housing;
a pin at least partially disposed within the interior chamber, wherein the pin is configured to selectively extend outward from the housing through the pin aperture from a retracted position to an engagement position to engage the bracket to secure the moving portion of the vehicle seat to the stationary portion; and
a biasing element disposed within the interior chamber and configured to provide a biasing force to the pin to bias the pin toward the retracted position;
wherein, responsive to an acceleration of the linear inertial latch being greater than or equal to an acceleration threshold, the pin overcomes the biasing force and translates into the engagement position such that the pin engages the bracket to secure the moving portion relative to the stationary portion.

2. The linear inertial latch assembly of claim 1, wherein the bracket includes a first leg configured to couple to the stationary portion and a second leg extending above the first leg that is selectively engaged by the pin.

3. The linear inertial latch assembly of claim 1, wherein the biasing element is a spring that is compressed when the acceleration of the linear inertial latch is greater than or equal to the acceleration threshold to allow for the pin to translate into the engagement position.

4. The linear inertial latch assembly of claim 1, wherein the biasing element inhibits the pin from moving from the retracted position into the engagement position when the acceleration of the linear inertial latch is below the acceleration threshold.

5. The linear inertial latch assembly of claim 1, further comprising a damper disposed between the housing and the pin, wherein the pin engages with the damper when in the retracted position.

6. The linear inertial latch assembly of claim 1, wherein the pin includes:
a body portion received within the interior chamber; and
a mandrel portion coupled to the body portion and extending through the pin aperture.

7. The linear inertial latch assembly of claim 6, wherein a first profile of the body portion is larger than a second profile of the pin aperture such that the pin is not able to fully pass through the pin aperture.

8. The linear inertial latch assembly of claim 6, wherein:
a first end of the mandrel portion is coupled to the body portion;
the pin includes a head portion coupled to an opposing second end of the mandrel portion; and
a profile of the head portion is larger than a profile of the pin aperture such that the pin is not able to fully pass through the pin aperture.

9. The linear inertial latch assembly of claim 8, wherein the mandrel portion and the head portion cooperatively define a pin engagement surface that engages the bracket when the pin is in the engagement position.

10. The linear inertial latch assembly of claim 9, wherein:
a first side of the head portion defines the pin engagement surface; and
the head portion includes a protrusion extending from an opposing second side of the head portion configured to engage the housing when the pin is in the retracted position to inhibit further retraction of the pin.

11. The linear inertial latch assembly of claim 6, wherein the biasing element is positioned between the housing and the body portion.

12. A frame assembly for a vehicle, the frame assembly comprising:
a frame portion;
a seat portion of a vehicle seat, the seat portion pivotably coupled to the frame portion; and
a linear inertial latch assembly for securing the seat portion to the frame portion, the linear inertial latch assembly including:
a bracket coupled to the frame portion; and
a linear inertial latch coupled to the seat portion, the linear inertial latch configured to selectively transition from a retracted configuration to an extended configuration to engage the bracket to secure the seat portion to the frame portion;
wherein, responsive to an acceleration of the linear inertial latch being greater than or equal to an acceleration threshold, the linear inertial latch transitions from the retracted configuration to the extended configuration to secure the seat portion relative to the frame portion.

13. The frame assembly of claim 12, wherein the linear inertial latch includes:
a pin configured to selectively extend from a retracted position when the linear inertial latch is in the retracted configuration to an engagement position when the linear inertial latch is in the extended configuration to engage the bracket to secure the seat portion to the frame portion; and
a biasing element configured to provide a biasing force to the pin to bias the pin toward the retracted position such that the linear inertial latch is biased toward the retracted configuration.

14. The frame assembly of claim 13, wherein the biasing element inhibits the pin from moving from the retracted position into the engagement position when the acceleration of the linear inertial latch is below the acceleration threshold.

15. The frame assembly of claim 13, wherein the linear inertial latch includes a damper positioned to engage the pin when the pin is in the retracted position.

16. The frame assembly of claim 12, wherein:
the seat portion is pivotably coupled to the frame portion at a first end portion of the seat portion; and
the linear inertial latch is coupled to the seat portion proximate an opposing second end portion of the seat portion.

17. The frame assembly of claim 12, wherein:
the seat portion is configured to pivot relative to the frame portion between a stowed position and a raised position; and
the linear inertial latch aligns with the bracket to selectively secure the seat portion to the frame portion when the seat portion is in the stowed position.

18. A linear inertial latch comprising:
a housing defining an interior chamber and a pin aperture extending through the housing;
a pin at least partially disposed within the interior chamber, wherein the pin is configured to selectively extend outward from the housing through the pin aperture from a retracted position to an engagement position to engage a stationary element, the pin including:
a body portion received within the interior chamber; and
a mandrel portion coupled to the body portion and extending through the pin aperture; and
a biasing element disposed within the interior chamber and configured to provide a biasing force to the pin to bias the pin toward the retracted position;
wherein, responsive to an acceleration of the linear inertial latch being greater than or equal to an acceleration threshold, the pin overcomes the biasing force and translates into the engagement position such that the pin engages the stationary element.

19. The linear inertial latch of claim 18, wherein the biasing element includes a spring extending between the housing and the body portion.

20. The linear inertial latch of claim 18, further comprising a damper disposed between the housing and the pin, wherein the pin engages with the damper when in the retracted position.
